(19) United States
(12) Patent Application Publication
(10) Pub. No.: US 2026/0211078 A1
(43) Pub. Date: Jul. 23, 2026

(54) RADAR DEVICE, RADAR CONTROL METHOD, AND NON-TRANSITORY COMPUTER READABLE MEDIUM

(71) Applicant: DENSO CORPORATION, Kariya-city (JP)

(72) Inventors: Tatsuya ENAMI, Kariya-city (JP); Osamu ISAJI, Kariya-city (JP); Yukou MURASE, Kariya-city (JP); Yasuhiro IDE, Kariya-city (JP)

(21) Appl. No.: 19/572,006

(22) Filed: Mar. 19, 2026

Related U.S. Application Data
(63) Continuation of application No. PCT/JP2024/033825, filed on Sep. 24, 2024.

(30) Foreign Application Priority Data
Sep. 25, 2023 (JP) 2023-161605

(51) Int. Cl. G01S 7/28; G01S 13/931

(52) U.S. Cl. CPC G01S 7/2813; G01S 13/931

(57) ABSTRACT

A radar device includes a transmission antenna, a reception antenna, and at least one of a circuit and a processor with memory storing executable code. The circuit or processor generates multiple coded transmit signals, and the reception antenna receives a mixed signal formed by reflections. The circuit or processor acquires the mixed signal from a specific reception antenna and generates decoded signals for the respective codes. A removal process estimates a sidelobe component detected in another decoded signal in correlation with a target component corresponding to a selected transmit signal, removes the estimated sidelobe component from a specific decoded signal or an associated related signal, and sets the correlation target after a previous removal as the target component. The device determines the number of removal executions based on a peak-to-thermal-noise ratio and repeats the removal accordingly.

### CROSS REFERENCE TO RELATED APPLICATION

The present application is a continuation application of International Patent Application No. PCT/JP2024/033825 filed on Sep. 24, 2024, which designated the U.S. and claims the benefit of priority from Japanese Patent Application No. 2023-161605 filed on Sep. 25, 2023. The entire disclosures of all of the above applications are incorporated herein by reference.

### TECHNICAL FIELD

The present disclosure relates to a technology for controlling a radar device.

### BACKGROUND

As a conventional radar, there is a MIMO (Multiple-Input-Multiple-Output) radar that uses a pseudo-random phase modulation method.

### SUMMARY

According to at least one embodiment, a radar device includes a transmission antenna, a reception antenna, and at least one of (i) a circuit and (ii) a processor having a memory storing computer program code executable by the processor. The at least one of the circuit and the processor generates types of transmitted signals that are modulated by respective codes for transmission from the transmission antenna. The reception antenna receives a mixed received signal in which the transmitted signals, after being reflected by a reflector, are mixed. The at least one of the circuit and the processor acquires the mixed received signal received by a specific reception antenna, and generates decoded signals corresponding to the respective codes for each transmitted signal. The at least one of the circuit and the processor performs a removal process that estimates a sidelobe signal component, which is a received signal component detected in another decoded signal, in correlation with a target signal component. The target signal component is a received signal component corresponding to a transmitted signal targeted in a specific decoded signal. The at least one of the circuit and the processor removes the sidelobe signal component from the specific decoded signal or from a related signal associated with the decoded signals. The removal process sets a correlation target of the sidelobe signal component as the target signal component of the specific decoded signal after a previous removal process. The at least one of the circuit and the processor determines a number of executions of the removal process to be at least correlated with a ratio of peak intensity to thermal noise intensity in the specific decoded signal prior to execution of the removal process. The at least one of the circuit and the processor repeatedly performs the removal process for the determined number of times.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating an overall configuration of a radar device according to a first embodiment.

FIG. 2 is a block diagram illustrating a functional configuration of a control unit according to the first embodiment.

FIG. 3 is a graph illustrating an example of a transmitted signal according to the first embodiment.

FIG. 4 is a flowchart illustrating a radar control method according to the first embodiment.

FIG. 5 is a schematic diagram illustrating an overview of signal processing for generating a frequency spectrum of a decoded signal from a distance bin signal.

FIG. 6 is an example of a frequency spectrum for illustrating definition of S/N ratio (signal-to-noise ratio).

FIG. 7 is a graph illustrating an example of the number of iterations correlated with the S/N ratio.

FIG. 8 is a schematic diagram illustrating an overview of the iteration process.

FIG. 9 is a schematic diagram illustrating a difference between cases where sidelobe signal components are suppressed and cases where they are not suppressed.

FIG. 10 is a diagram illustrating an example of the number of iterations correlated with S/N ratio and the number of peaks in a second embodiment.

FIG. 11 is a graph for explaining peak positions correlated with the number of iterations in a third embodiment.

FIG. 12 is a flowchart illustrating a radar control method according to a fourth embodiment.

FIG. 13 is a flowchart illustrating a radar control method according to a fifth embodiment.

FIG. 14 is a graph illustrating an example of a buried peak determined in the radar control method of the fifth embodiment.

### DETAILED DESCRIPTION

To begin with, examples of relevant techniques will be described.

A MIMO radar according to a comparative example uses a pseudo-random phase modulation scheme. This MIMO radar transmits transmitted signals modulated by different CDM (Code Division Multiplexing) codes from each transmission antenna. The MIMO radar generates a decoded signal spectrum for the received signal according to each CDM code, and estimates sidelobe signal components from each decoded signal spectrum. The MIMO radar can obtain a decoded signal spectrum with suppressed sidelobe signal components by subtracting each estimated sidelobe signal component from the decoded signal spectrum corresponding to the target transmission antenna. To further enhance the suppression of sidelobe signal components, the MIMO radar estimates sidelobe signal components again from the decoded signal spectrum with suppressed sidelobe signal components and subtracts them from the decoded signal spectrum once more, thereby performing the sidelobe suppression process multiple times.

The MIMO radar of the comparative example cannot determine the number of times the sidelobe suppression process is performed according to the situation.

In contrast to the comparative example, according to a radar device, a radar control method, and a radar control program of the present disclosure, sidelobe signal component suppression processing can be performed multiple times depending on the situation.

According to one aspect of the present disclosure, a radar device includes a transmission antenna, a reception antenna, and at least one of (i) a circuit and (ii) a processor having a memory storing computer program code executable by the processor. The at least one of the circuit and the processor generates types of transmitted signals that are modulated by respective codes for transmission from the transmission antenna. The reception antenna receives a mixed received signal in which the transmitted signals, after being reflected by a reflector, are mixed. The at least one of the circuit and the processor acquires the mixed received signal received by a specific reception antenna, and generates decoded signals corresponding to the respective codes for each transmitted signal. The at least one of the circuit and the processor performs a removal process that estimates a sidelobe signal component, which is a received signal component detected in another decoded signal, in correlation with a target signal component. The target signal component is a received signal component corresponding to a transmitted signal targeted in a specific decoded signal. The at least one of the circuit and the processor removes the sidelobe signal component from the specific decoded signal or from a related signal associated with the decoded signals. The removal process sets a correlation target of the sidelobe signal component as the target signal component of the specific decoded signal after a previous removal process. The at least one of the circuit and the processor determines a number of executions of the removal process to be at least correlated with a ratio of peak intensity to thermal noise intensity in the specific decoded signal prior to execution of the removal process. The at least one of the circuit and the processor repeatedly performs the removal process for the determined number of times.

According to this configuration, the removal process is executed a number of times at least correlated with the ratio of the intensity of the peak in the specific decoded signal to the intensity of thermal noise. Since the ratio of the peak intensity to the thermal noise intensity correlates with the magnitude of the sidelobe signal component, by removing the sidelobe signal component a number of times corresponding to this ratio, the sidelobe signal component can be sufficiently reduced. Therefore, it becomes possible to execute the suppression processing of the sidelobe signal component a number of times corresponding to the situation.

Hereinafter, several embodiments of the present disclosure will be described with reference to the drawings. In the respective embodiments, corresponding components are denoted by the same reference numerals, and redundant descriptions may be omitted. Further, in cases where only a part of a configuration is described in each embodiment, the other parts of the configuration may be applied using the configurations described in the preceding embodiments. Furthermore, in the descriptions of each embodiment, not only the explicitly stated combinations of configurations, but also, unless there is a specific impediment to such combinations, portions of the configurations of multiple embodiments may be partially combined even if not expressly stated.

### First Embodiment

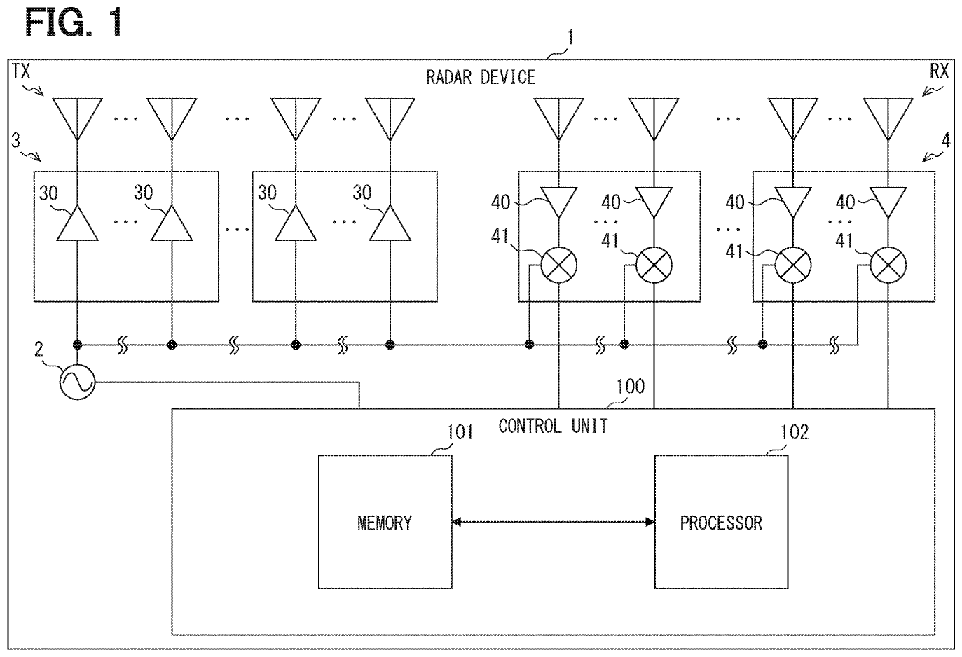

A first embodiment of the present disclosure will be described with reference to FIGS. 1 to 9. A radar device 1 is mounted on a moving object such as a vehicle. The radar device 1 transmits transmitted signals to an external environment, receives as received signals the transmitted signals reflected by objects, and detects, as target information, a distance to a target which is a reflector that has reflected the transmitted signal, a relative velocity with respect to the target, a direction of the target, and the like.

The target information output from the radar device 1 is input to an in-vehicle ECU (electronic control unit) via an in-vehicle network such as a Control Area Network (CAN) (registered trademark) or Ethernet (registered trademark). The in-vehicle ECU executes various processes for automated driving of the vehicle and advanced driving assistance based on the acquired target information of each target.

The processes based on the target information include, for example, collision avoidance processes and warning processes. The collision avoidance process is a process of controlling the vehicle to avoid collision with the target by controlling a brake system and a steering system based on the target information of each target. The warning process is a process for warning a driver of a possibility of a collision with the target based on the target information of each target.

As shown in FIG. 1, the radar device 1 of the present embodiment includes a transmitted signal generation unit 2, transmission circuits 3, transmission antennas TX, reception antennas RX, reception circuits 4, and a control unit 100. The radar device 1 is a so-called MIMO (Multiple-Input-Multiple-Output) radar that transmits transmitted signals from multiple transmission antennas TX to artificially increase the number of reception antennas RX beyond the actual number.

The transmitted signal generation unit 2 acquires a control signal from the control unit 100 and generates a signal modulated in accordance with the control signal. This generated signal is, for example, a so-called chirp signal in which the frequency changes over time (see FIG. 3). The generated signal is distributed to and output to each channel of the transmission circuits 3 and the reception circuits 4. The transmitted signal generation unit 2 outputs, as transmitted signals, generated signals to which pseudo-random phase modulation with different codes is applied for each transmission channel corresponding to each transmission antenna TX. Such a modulation scheme is referred to as code division multiplexing (CDM: Code Division Multiplex). As shown in FIG. 3, in the present embodiment, the transmitted signals transmitted from the different transmission antennas TX are assumed to have substantially the same chirp transmission timing, center frequency, and frequency bandwidth. In FIG. 3, an example of transmitted signals transmitted from two different transmission antennas TX is represented by different line types, namely, a solid line and a dashed line.

That is, in the present embodiment, from each of the transmission antennas TX, transmitted signals to which phase modulation by mutually different codes has been applied are transmitted to the external environment. In addition, among the generated signals, the signal output to the reception circuit 4 with respect to the transmitted signal will hereinafter be referred to as a “local signal.”

The transmission circuits 3 and the reception circuits 4 are each mainly composed of a semiconductor integrated circuit device such as an MMIC (Monolithic Microwave Integrated Circuit). The transmission circuits 3 are connected to the transmission antennas TX and outputs the transmitted signal to the transmission antennas TX. A transmission circuit 3 of the transmission circuits 3 includes amplifiers 30 in the same number as the number of connected transmission antennas TX. The amplifiers 30 amplify the transmitted signal output from the transmitted signal generation unit 2 and output the amplified signals to the corresponding transmission antennas TX.

The transmission antenna TX converts an electrical signal, which is a transmitted signal supplied from the transmitted signal generation unit 2, into a radio wave signal and transmits it to an external environment. In the present embodiment, it is assumed that twelve transmission antennas TX are provided. Hereinafter, when distinguishing each transmission antenna TX individually, it will be denoted as TXn (where “n” is a natural number from 1 to 12). A transmission antenna TX of the transmission antennas TX includes at least one antenna element. For example, the transmission antenna TX is a patch antenna having flat-plate-shaped antenna elements. The antenna element is provided on a dielectric substrate. The dielectric substrate has a surface on which a ground plane is provided and a surface on which the antenna element is provided. The antenna element is provided on the dielectric substrate in a position facing the ground plane. The multiple antenna elements are connected, for example, in series, by a feed line that supplies an electric signal.

A reception antenna RX of the reception antennas RX receives, as a received signal, a radio wave signal including a transmitted signal reflected from a target in the external environment as a reflecting object. Each of the reception antennas RX receives a signal in which the received signals corresponding to the respective transmitted signals from the transmission antennas TX are mixed. Hereinafter, the signal in this mixed state received by each reception antenna RX will be referred to as a “mixed received signal.” Furthermore, the components of each received signal corresponding to each transmitted signal from the transmission antennas TX, which are mixed in the mixed received signal, will be referred to as “received signal components.”

The reception antenna RX converts the received signal, which is a radio wave signal, into an electric signal and outputs it to the corresponding reception circuit 4. The reception antenna RX is, for example, a patch antenna having at least one antenna element connected in series by a feeder line, similar to the transmission antenna TX.

The reception circuit 4 is connected to the reception antenna RX and acquires the received signal received by the reception antenna RX for each reception channel corresponding to each reception antenna RX. The reception circuit 4 includes amplifiers 40 and signal mixing units 41, the number of which is equal to the number of reception antennas RX connected.

An amplifier 40 amplifies the received signal received by the reception antenna and outputs the amplified signal to a signal mixing unit 41. The signal mixing unit 41 generates a beat signal by mixing the local signal from the transmitted signal generation unit 2 with the received signal. The generated beat signal is an interference signal that represents a frequency difference between the received signal and the local signal. The beat signal is output to the control unit 100 after high-frequency components outside the frequency difference between the received signal and the local signal are filtered out by a low-pass filter (not shown).

The control unit 100 is connected to the transmitted signal generation unit 2 and the reception circuit 4 via at least one type of connection, such as a LAN (Local Area Network) line, wiring harness, internal bus, or wireless communication line. The control unit 100 is configured to include at least one dedicated computer.

The dedicated computer constituting the control unit 100 may be a radar ECU (Electronic Control Unit) specialized for controlling a specific radar device 1. The dedicated computer constituting the control unit 100 may also be a radar supervisory ECU that collectively controls multiple radar devices 1 mounted on the moving object. The dedicated computer constituting the control unit 100 may also be a sensor supervisory ECU that collectively controls multiple sensors, including the radar device 1 and other sensors such as LiDAR (Light Detection and Ranging/Laser Imaging Detection and Ranging).

The dedicated computer constituting the control unit 100 includes at least one memory 101 and at least one processor 102. The memory 101 is at least one type of non-transitory tangible storage medium, which non-transitorily stores computer-readable programs and data. Examples of the non transitory tangible storage medium include semiconductor medium, magnetic medium, and optical medium. Here, the storage may refer to storage where data is retained even when the vehicle is turned off, or the storage may refer to temporary storage where data is erased when the vehicle is turned off. The processor 102 includes, as a processing core, at least one type of a Central Processing Unit (CPU), a Graphics Processing Unit (GPU), a Reduced Instruction Set Computer (RISC)-CPU, a Data Flow Processor (DFP), and a Graph Streaming Processor (GSP).

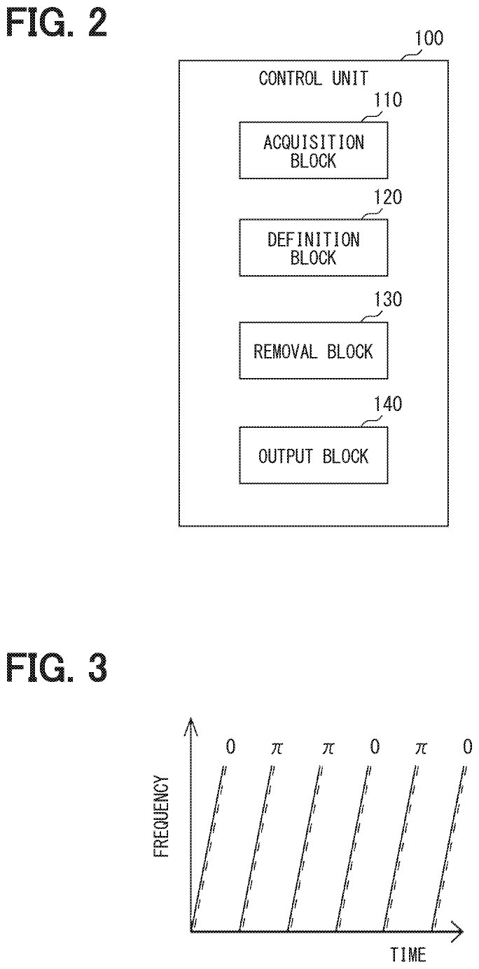

In the control unit 100, the processor 102 executes instructions included in a radar control program stored in the memory 101, which is a storage medium, in order to control the radar device 1. As a result, the control unit 100 constructs functional blocks for controlling the radar device 1. The functional blocks constructed in the control unit 100 include, as shown in FIG. 2, an acquisition block 110, a definition block 120, a removal block 130, and an output block 140. It should be noted that each of the above functional blocks may also be referred to as functional units, namely, an acquisition unit, a definition unit, a removal unit, and an output unit, respectively.

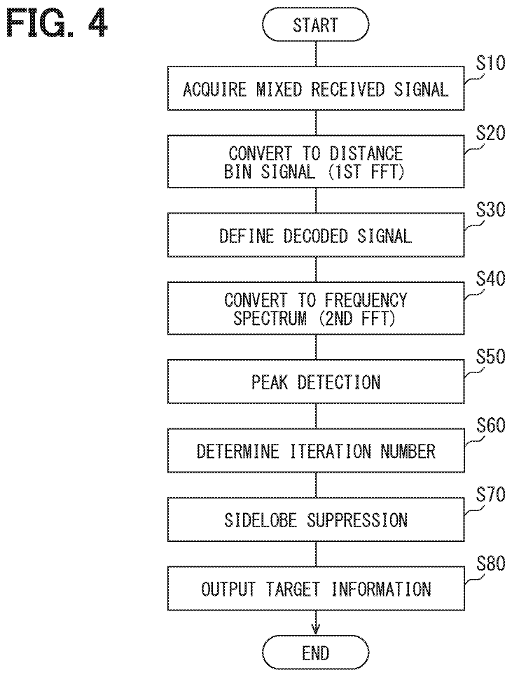

Through the cooperation of these blocks 110, 120, 130, and 140, the radar control method by which the control unit 100 controls the radar device 1 is executed in accordance with the radar control flow shown in FIG. 4. The radar control flow is repeatedly executed while the radar device 1 is operating. This radar control flow is executed, for example, for each reception channel, and one cycle is defined as the process in which all reception channels have been processed once. Here, in the radar control flow, “S” means steps of the process executed by instructions included in the radar control program.

First, in S10, the acquisition block 110 acquires the mixed received signal. The mixed received signal is a beat signal obtained by mixing a local signal from the signal generation unit with a received signal from the reception antenna RX. The beat signal is an interference signal that represents the frequency difference between the received signal and the local signal. The mixed received signal is acquired as a digitized digital signal that has been sampled at predetermined time intervals by an A/D converter.

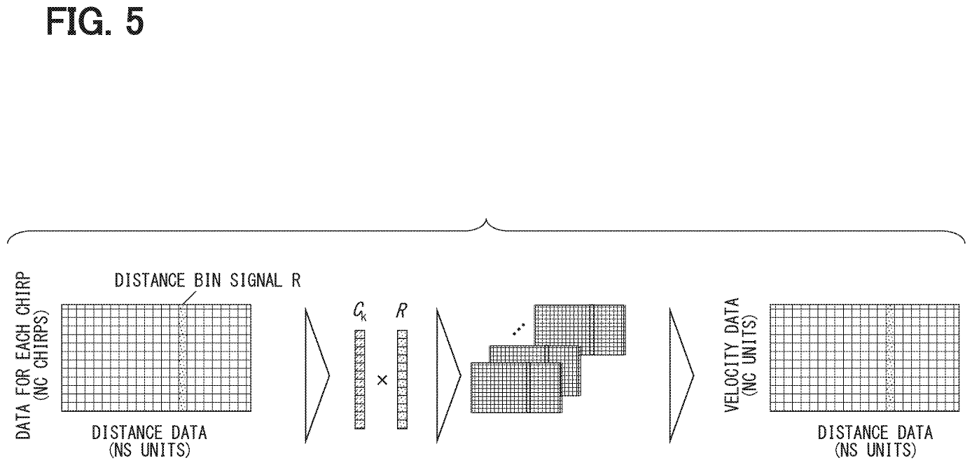

Subsequently, in S20, the definition block 120 performs a Fast Fourier Transform (FFT) on the mixed received signal. As a result, the definition block 120 obtains a distance spectrum of each chirp in the mixed received signal. The obtained distance spectrum is a frequency spectrum that exhibits peaks corresponding to the distance to the target, and is discrete distance data that includes signal intensity information for each bin (distance bin) corresponding to a distance, as distance information. Hereafter, as shown in FIG. 5, the Ns samples of each of the Nc chirps are converted into distance data by FFT processing, and the data obtained by extracting Nc samples for a specific distance bin is referred to as the distance bin signal R. Here, the received signal component originating from the transmitted signal from the transmission antenna TXn and encoded by the code Cₜₓₙ is denoted as Pₙ. The distance bin signal R before decoding can be defined by the following equation (1) as the sum of the received signal components CₜₓₙPₙ before decoding from each transmission antenna TX.

$$Equation 1$$

$$R = {\sum }_{k} {C}_{t x k} {P}_{k} \qquad ( 1 )$$

In S30, the definition block 120 defines a decoded signal corresponding to the distance bin signal R. Specifically, the definition block 120 generates, for each code corresponding to each transmission antenna TX, a decoded signal by decoding the distance bin signal R using that code. The definition block 120 stores each decoded signal for each code in the memory 101.

For example, suppose that the transmission antenna TX1 is the target transmission antenna. In this case, in S30, the definition block 120 performs decoding for those codes among the codes Cₜₓ₂ to Cₜₓ₁₂ corresponding to the other transmission antennas TX2 to TX12 that have not yet been decoded in the previous loops. For example, when decoding is to be performed for a specific code Cₜₓₙ, the decoded signal is represented by the following equation (2) using the code Cₜₓₙ*for decoding the phase modulation by Cₜₓₙ. Here, the code Cₜₓₙ* is a code which, when multiplied by Cₜₓₙ, results in all elements becoming one.

$$Equation 2$$

$$R {C}_{t x n}^{*} = {\sum }_{k} {C}_{t x n}^{*} {C}_{t x k} {P}_{k} \qquad ( 2 )$$

In the subsequent S40, the definition block 120 performs a fast Fourier transform (FFT) on the decoded signal. As a result, the definition block 120 obtains the Doppler frequency spectrum of the mixed received signal. This frequency spectrum is a velocity spectrum that exhibits peaks corresponding to the speed of the target, and is discrete signal data that includes signal intensity information for each bin (velocity bin) corresponding to speed. By means of this second FFT processing, the definition block 120 can obtain two-dimensional map data of distance and velocity, as shown in FIG. 5. This two-dimensional map data may also be referred to as an RV map. It should be noted that, in the fast Fourier transform processing, the definition block 120 multiplies a window function to the distance bin signal R. In this processing, window functions other than the rectangular function may include, for example, a Hanning function or a Gaussian function.

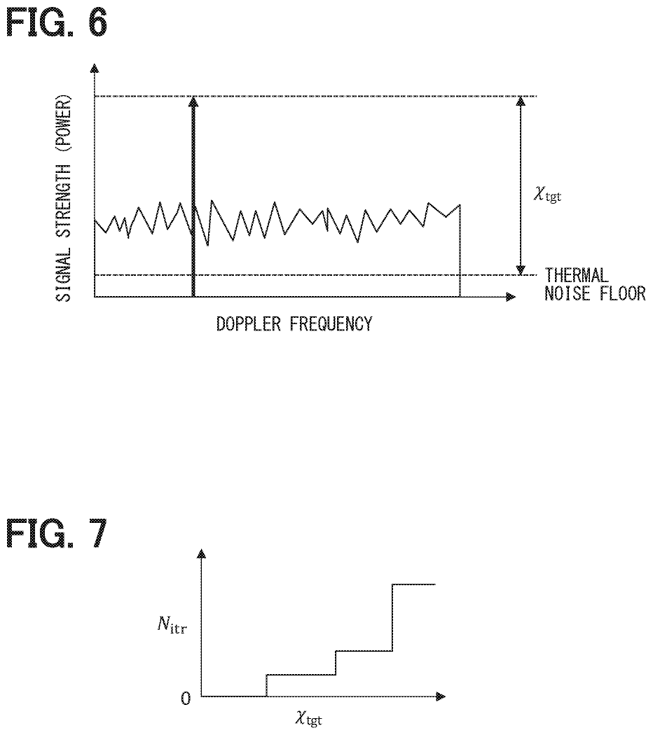

In the above equation (2), when k=n, a coefficient of Pₙ becomes 1. Therefore, as shown in FIG. 6, the velocity spectrum is a combination of the spectrum of the peak Pₙ and the diffused spectrum resulting from the other terms. The spectrum resulting from terms other than Pₙ corresponds to sidelobe signal components.

In the subsequent step S50, the removal block 130 detects peaks from the frequency spectrum. For the peak detection, the removal block 130 may, for example, identify the frequency bin where the intensity is at a maximum as a peak position. The removal block 130 detects peaks by performing, for example, a CFAR (Constant False Alarm Rate) process. The removal block 130 acquires at least the identified peak position and its peak intensity as peak information relating to the detected peak. The peak information may also include the phase or other data at the peak. In a case of the decoded signal RCₜₓₙ*, the peak detection corresponds to detecting Pₙ in equation (2). A peak in the frequency spectrum of the decoded signal is an example of a “target signal component,” which is a received signal component corresponding to the transmitted signal targeted in the decoded signal.

Then, in S60, the removal block 130 determines the number of iterations. Here, a term “iteration” means estimating new sidelobe signal components in other decoded signals from the peak of the decoded signal after the removal process, and removing the new sidelobe signal components from the decoded signals. That is, the iteration corresponds to a process in which the correlation target for the sidelobe signal components is set to the peak of a specific decoded signal after the previous removal process, the sidelobe signal components correlated with that peak are estimated, and the removal process is further repeated using those sidelobe signal components.

The removal block 130 determines the number of iterations Nᵢₜᵣ, which at least correlates with an S/N ratio_{Xtgt} in the frequency spectrum of the decoded signal corresponding to the target transmitted signal. The S/N ratio_{xtgt} is a ratio from the peak intensity in the decoded signal to the magnitude of the thermal noise floor, that is, the ratio of the peak intensity to the thermal noise floor in the decoded signal. The removal block 130 may, for example, obtain thermal noise as a theoretically estimable parameter correlated with a circuit configuration and ambient temperature of the radar device 1. Alternatively, the removal block 130 may obtain thermal noise as a parameter correlated with the received signal strength in regions of the RV map where no target is present. It should be noted that when the removal block 130 obtains thermal noise as a parameter correlated with the received signal strength, it may acquire thermal noise corresponding to an average value or a median value of the received signal strength in the aforementioned region. Alternatively, the removal block 130 may obtain thermal noise corresponding to a mode value of the received signal strength in the aforementioned region.

When multiple peaks are present in the frequency spectrum, the removal block 130 may correlate the S/N ratio_{Xtgt} with the peak having the maximum intensity. Alternatively, the removal block 130 may correlate the number of iterations Nᵢₜᵣ with the sum of the S/N ratios_{Xtgt} of each peak. Alternatively, the removal block 130 may correlate the number of iterations Nᵢₜᵣ with the average of the S/N ratios_{Xtgt} of each peak.

For example, as shown in a graph of FIG. 7, the removal block 130 determines a larger number of iterations Nᵢₜᵣ as the S/N ratio_{Xtgt} increases. Relationship information regarding the correlation between the S/N ratio_{Xtgt} and the number of iterations Nᵢₜᵣ is stored in the memory 101 in the form of a function or a table. The removal block 130 determines the number of iterations Nᵢₜᵣ according to the stored relationship information and the acquired S/N ratio_{Xtgt}.

In the subsequent step S70, the removal block 130 performs the removal process. In the sidelobe suppression process, the removal block 130 removes the sidelobe signal components from the decoded signal RCₜₓₙ. Furthermore, the removal block 130 executes an iteration process in which the sidelobe suppression process is repeated for the determined number of iterations Nᵢₜᵣ.

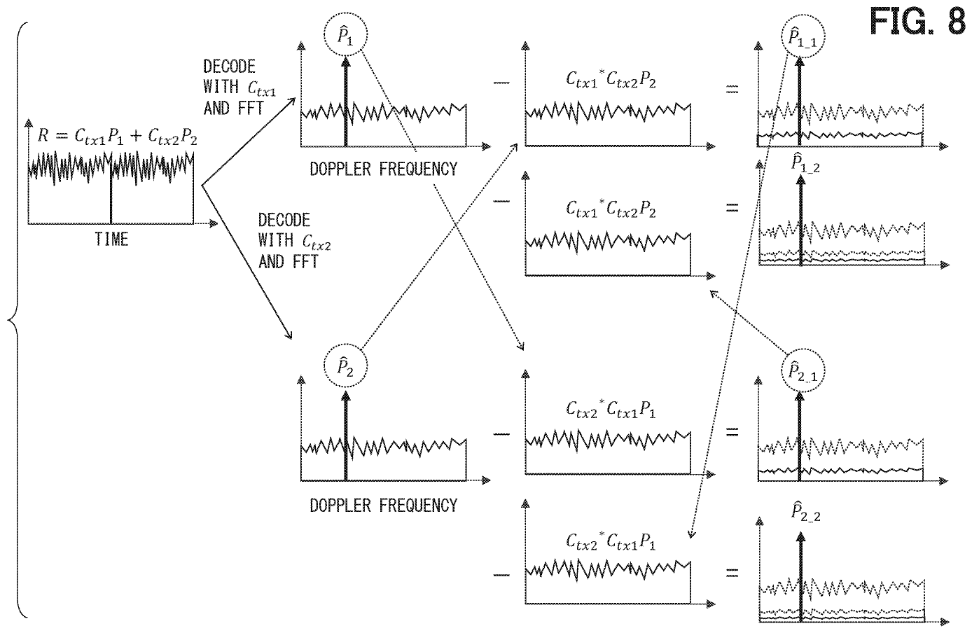

In the sidelobe suppression process, the removal block 130 estimates the sidelobe signal components included in the decoded signal, which has been decoded with the code corresponding to another transmitted signal, and which correlate with the peak of the decoded signal that has been decoded with the code corresponding to a certain transmitted signal. Here, for the sake of simplicity, the sidelobe suppression process will be described using, as an example, the distance bin signal R based on the received signal reflected from the target, in which transmitted signals respectively modulated by codes Cₜₓ₁ and Cₜₓ₂ from two transmission antennas TX1 and TX2, as shown in FIG. 8, are used. In this case, for each of the decoded signals RCₜₓ₁* and RCₜₓ₂*, the removal block 130 estimates the sidelobe signal components in the frequency spectrum of the other signal that correlate with the target peaks P₁ and P₂ in the frequency spectra.

More specifically, the removal block 130 calculates, from the peak P₁\hat{ } in the frequency spectrum of the decoded signal RCₜₓ₁*, the sidelobe signal component Cₜₓ₂*Cₜₓ₁P₁\hat{ } in the frequency spectrum of the decoded signal RCₜₓ₂*. Similarly, the removal block 130 calculates, from the peak P₂\hat{ } in the frequency spectrum of the decoded signal RCₜₓ₂*, the sidelobe signal component Cₜₓ₁*Cₜₓ₂P₂\hat{ } in the frequency spectrum of the decoded signal RCₜₓ₁*.

Then, the removal block 130 removes each sidelobe signal component by subtracting the estimated sidelobe signal component Cₜₓ₁*Cₜₓ₂P₂\hat{ } from the decoded signal RCₜₓ₁*, and the sidelobe signal component Cₜₓ₂*Cₜₓ₁P₁\hat{ } from the decoded signal RCₜₓ₂*. Hereinafter, the signal obtained by removing the sidelobe signal components from the decoded signal will be referred to as a “removed decoded signal.”

Furthermore, the removal block 130 performs an iteration process according to the determined number of iterations Nᵢₜᵣ. The iteration process involves re-estimating the sidelobe signal components in other decoded signals based on the peaks in the removed decoded signal, and removing the re-estimated sidelobe signal components from those other decoded signals.

In the example shown in FIG. 8, the removal block 130 calculates a new sidelobe signal component Cₜₓ₂*Cₜₓ₁P_{1_1}\hat{ } in the decoded signal RCₜₓ₂* based on the peak P_{1_1}\hat{ } in the removed decoded signal obtained from the decoded signal RCₜₓ₁*. Then, the removal block 130 subtracts this new sidelobe signal component Cₜₓ₂*Cₜₓ₁P_{1_1}\hat{f}rom the decoded signal RCₜₓ₂*. As a result, the removal block 130 obtains a further removed decoded signal in which the sidelobe signal component Cₜₓ₂*Cₜₓ₁P_{1_1}\hat{ } is suppressed. Similarly, the removal block 130 calculates a new sidelobe signal component Cₜₓ₁*Cₜₓ₂P_{2_1}\hat{ }based on the peak P_{2_1}\hat{ }, and obtains a further removed decoded signal by subtracting this component from the decoded signal RCₜₓ₁*.

The removal block 130 repeats the iteration process for the determined number of iterations Nᵢₜᵣ. It should be noted that, for simplicity, FIG. 8 shows an example in which the iteration process is performed only once. However, the removal block 130 can perform a second iteration process by further estimating the sidelobe signal components from each of the peaks P_{2_2}\hat{ } and P_{1_2}\hat{ }, and subtracting them from the decoded signals RCₜₓ₁* and RCₜₓ₂*. Similarly, by repeatedly estimating and removing the sidelobe signal components, the removal block 130 performs the iteration process for the determined number of iterations Nᵢₜᵣ. Furthermore, even when three or more types of codes are used in the modulation, the removal block 130 similarly performs the sidelobe suppression process. For example, the same applies even when the transmitted signals of each of the twelve transmission antennas (TX) are modulated with different codes. In this case, the removal block 130 estimates the sidelobe signal components from each peak in the twelve types of decoded signals, which have been decoded for each code, to the other decoded signals, and removes each sidelobe signal component from each decoded signal.

Subsequently, in S80, the output block 140 acquires target information from the frequency spectrum. The target information includes at least one type among the target's distance, speed, and direction. The output block 140 estimates the direction, for example, by using a Direction of Arrival (DoA) method. In the subsequent S130, the output block 140 outputs the target information to the outside.

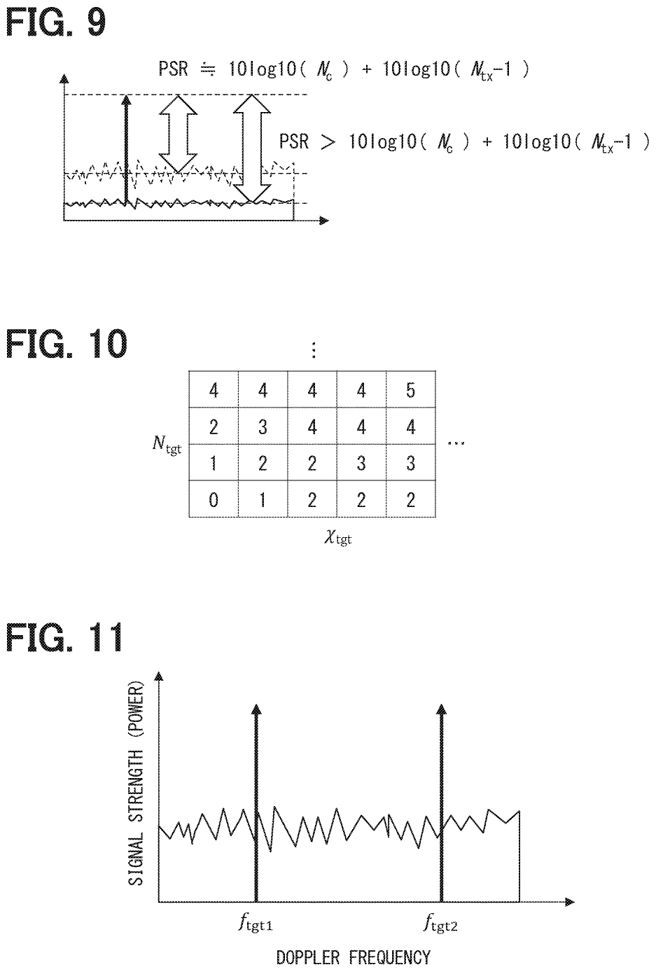

A difference in dynamic range PSR between a case where the above-mentioned sidelobe suppression is performed and a case where it is not performed will be explained with reference to FIG. 9. When a single target is assumed, the dynamic range PSR can be expressed as a ratio from the maximum value of the peak of the target to the sidelobe. When the removal processing is not executed, this dynamic range PSR satisfies a relationship shown in the following equation (3), where the total number of chirps in the transmitted signal is Nc and the number of transmission antennas modulated by the CDM code is Ntx.

$$Equation 3$$

$$PSR \approx 10 log 10 ( {N}_{c} ) + 10 log 10 ( {N}_{t x} - 1 ) \qquad ( 3 )$$

On the other hand, when the removal processing shown in the present embodiment is executed, the dynamic range PSR satisfies a relationship shown in the following equation (4).

$$Equation 4$$

$$P S R > 10 log 10 ( {N}_{c} ) + 10 log 10 ( {N}_{t x} - 1 ) \qquad ( 4 )$$

That is, in the radar device 1 that performs the sidelobe suppression, the dynamic range PSR becomes greater than in the radar device 1 that does not perform it.

According to the above first embodiment, the sidelobe signal is removed at least as many times as the number of correlations for which the ratio of the peak intensity in the received signal component corresponding to the target transmitted signal to the thermal noise is correlated. Since the ratio correlates with the magnitude of the sidelobe signal component, by removing the sidelobe signal component as many times as the ratio, the sidelobe signal component can be sufficiently suppressed. Therefore, it becomes possible to execute the suppression processing of the sidelobe signal component a number of times corresponding to the situation.

### Second Embodiment

As shown in FIG. 10, a second embodiment is a modification of the first embodiment.

In the second embodiment, a removal block 130 in S60 determines the number of iterations Nᵢₜᵣ correlated with not only the S/N ratio_{Xtgt} but also the number of peaks N_{tgt}. More specifically, as shown in FIG. 10, the removal block 130 determines a greater number of iterations Nᵢₜᵣ as the number of peaks N_{tgt} increases. That is, even if the signals have an equivalent S/N ratio_{Xtgt}, the number of iterations Nᵢₜᵣ for the signal will increase as the number of peaks N_{tgt} increases. The relationship information between the S/N ratio_{Xtgt} and the number of peaks N_{tgt}, and the number of iterations Nᵢₜᵣ, is stored in the memory 101 in the form of a function or a table. The removal block 130 determines the number of iterations Nᵢₜᵣ based on the stored relationship information, the acquired S/N ratio_{Xtgt}, and the number of peaks N_{tgt}.

### Third Embodiment

As shown in FIG. 11, a third embodiment is a modification of the first embodiment.

In the third embodiment, when there are multiple peaks in the frequency spectrum, a removal block 130 in S60 determines the number of iterations Nᵢₜᵣ in correlation with the Doppler frequency difference between the peaks, in addition to the S/N ratio_{Xtgt}. The Doppler frequency difference between peaks, as shown in FIG. 11, is the difference in Doppler frequency at each peak. When multiple peaks are present, a spectral shape of the entire sidelobe signal component is determined by an overlap of sidelobe signal components originating from each peak. The optimal number of iterations Nᵢₜᵣ varies depending on the position of each peak within the spectral shape of the entire sidelobe signal component. An optimal number of iterations Nᵢₜᵣ can be determined based on the Doppler frequency difference between the peaks, that is, the positional relationship between the peaks in the Doppler frequency domain, the code used, and the number of transmission antennas (TX).

Therefore, the removal block 130 determines the number of iterations Nᵢₜᵣ, which correlates with the Doppler frequency difference, the code used, and the number of transmission antennas (TX). The relationship Information between the S/N ratiox_{tgt}, the Doppler frequency difference, the code, the number of transmission antennas (TX), and the number of iterations Nᵢₜᵣ is stored in the memory 101 in the form of a function or table. The removal block 130 determines the number of iterations Nᵢₜᵣ in accordance with the stored relationship information, the acquired S/N ratio_{Xtgt}, the Doppler frequency difference, the code, and the number of transmission antennas (TX).

### Fourth Embodiment

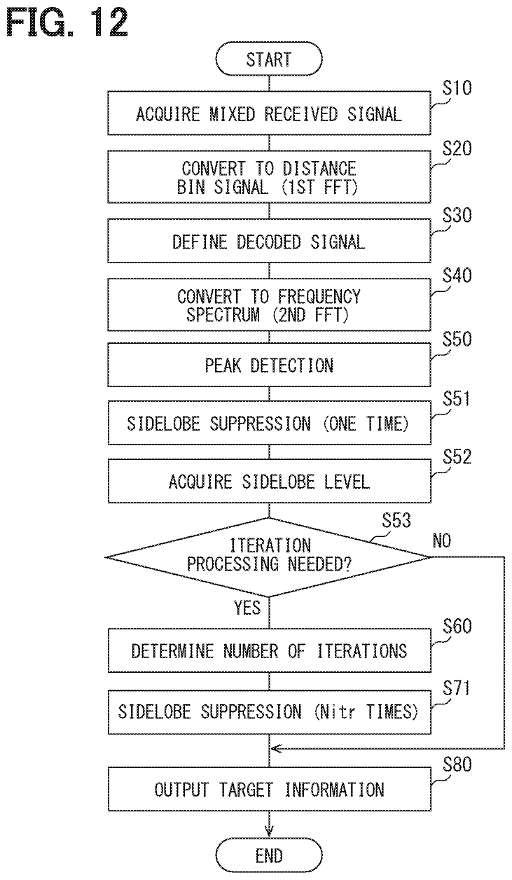

As shown in FIG. 12, a fourth embodiment is a modification of the first embodiment.

In the fourth embodiment, as shown in FIG. 12, the flow transitions from S50 to S51. In S51, a removal block 130 performs the removal of sidelobe signal components from the decoded signal only a prescribed number of times (for example, once). That is, at the time point of S51, the iterative processing to estimate and remove sidelobe signal components again from the already processed decoded signal is not performed. After the process of S51, this flow shifts to S52.

In S52, the removal block 130 acquires a sidelobe level, which is the magnitude (intensity) of the sidelobe signal components after sidelobe suppression in S51. The removal block 130 acquires an average value or a median value of the sidelobe signal components in at least a part of the frequency spectrum as the sidelobe level. After the process of S52, this flow shifts to S53.

In S53, the removal block 130 determines whether to execute the iteration process according to the sidelobe level. For example, the removal block 130 determines that iteration processing is unnecessary when the sidelobe level falls within an upper limit of an allowable level range, and determines that iteration processing is necessary when the sidelobe level exceeds the upper limit of the allowable level range. Here, the allowable level range is, for example, a range in which the sidelobe level is less than or equal to or less than a threshold value, and the upper limit is the threshold value. The threshold value is, for example, a value correlated with a magnitude of the noise floor of thermal noise. The allowable level range is an example of an “allowable intensity range.” It should be noted that determining that iteration processing is unnecessary in S53 can also be expressed as deciding that the number of iterations Nᵢₜᵣ is zero.

When it is determined in S53 that iteration processing is unnecessary, the flow proceeds to S80. On the other hand, when it is determined in S53 that iteration processing is necessary, the flow proceeds to S60, where the number of iterations Nᵢₜᵣ is determined. Even if it is determined that iteration processing is necessary based on the sidelobe level, depending on the magnitude of the S/N ratio_{Xtgt}, it is also possible that the number of iterations Nᵢₜᵣ is determined to be zero in S60.

After the process of S60, this flow shifts to S71. In S71, the removal block 130 executes the iteration processing according to the determined number of iterations Nᵢₜᵣ. Also in S71, as in S70 of the first embodiment, there may be cases where the iteration processing is executed zero times, that is, where the iteration processing is not executed. After the process of S71, this flow shifts to S80.

### Fifth Embodiment

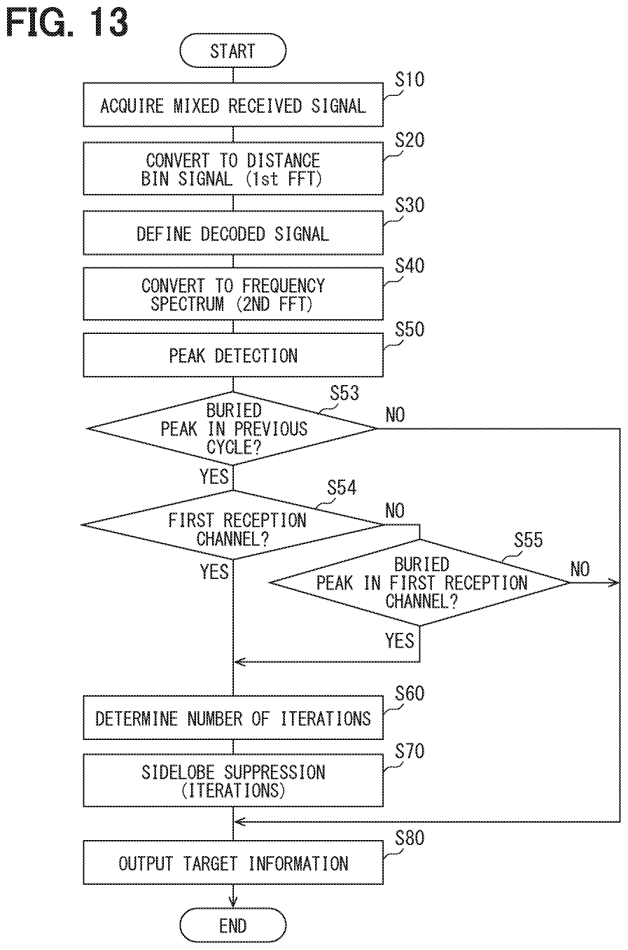

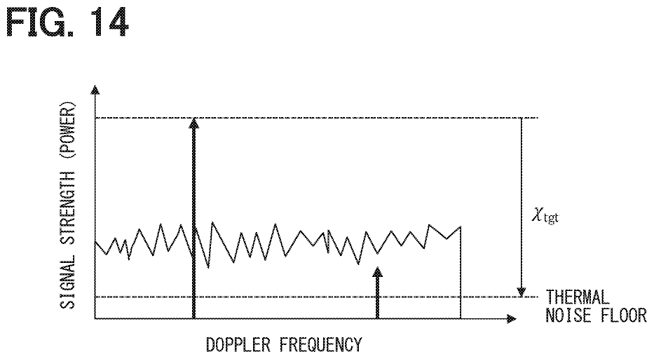

A fifth embodiment shown in FIGS. 13, 14 is a modification of the first embodiment.

In the fifth embodiment, as shown in FIG. 13, the flow proceeds to S53 after S50. In S53, a removal block 130 determines whether there is a buried peak in the previous cycle. Here, as shown in FIG. 14, the buried peak refers to a peak that is obscured by the sidelobe signal component in the frequency spectrum of the decoded signal before suppression of the sidelobe signal component. In other words, the buried peak is a peak that has a lower intensity than the sidelobe signal component.

When it is determined that a buried peak exists, the flow proceeds to S54. In S54, the removal block 130 determines whether the current reception antenna RX is a first reception antenna RX to perform the sidelobe suppression processing in the current cycle. When it is determined that it is the first reception antenna RX to perform the sidelobe suppression, the flow proceeds to S60. On the other hand, when it is determined that it is not the first reception antenna RX, the flow proceeds to S55. In S55, the removal block 130 determines whether there is the buried peak in the first reception antenna RX. When it is determined that there is the buried peak, the flow proceeds to S60.

On the other hand, when it is determined in S53 that there was no buried peak in the previous cycle, that is, the buried peak was not detected, or when it is determined in S55 that there is no buried peak in the first reception antenna, the flow proceeds to S55. That is, when it is determined that there is no buried peak, the sidelobe suppression process is interrupted.

### Other Embodiments

As described above, several embodiments have been explained, but the present disclosure is not to be construed as being limited to these embodiments, and can be applied to various embodiments and combinations thereof without departing from the spirit of the disclosure.

In a modification, the removal block 130 may remove the sidelobe signal component from the distance bin signal instead of from the decoded signal. In this case, the distance bin signal is an example of a “related signal” associated with the decoded signal.

In a modification, the transmitted signal generation unit 2 may apply modulation with different codes for each antenna set including the transmission antennas TX. In this case, different codes are applied to the transmitted signals for each of the antenna sets, each including a predetermined number of transmission antennas TX. In this case, the control unit 100 performs the removal process for each code of each antenna set. In addition, the transmitted signals corresponding to each transmission antenna TX within the antenna set are subjected to phase shift modulation or amplitude modulation, making it possible to separate the corresponding received signal components for each transmitted signal.

In a modification, the output block 140 of S80 may output the frequency spectrum to the outside as the target information. For example, the output block 140 outputs the frequency spectrum to an external in-vehicle ECU outside the radar device 1. In this case, the position and other information of the target are obtained from the peaks of the target contained in the frequency spectrum by the destination in-vehicle ECU.

In a modification, the radar device 1 may be provided with only a single transmission antenna TX. In this case, the transmitted signal generation unit 2 generates a transmitted signal in which multiple transmitted signals, each modulated by a different code, are mixed for the single transmission antenna.

In a modification, the dedicated computer constituting the control unit 100 may be an integrated ECU that integrates driving control of the vehicle. The dedicated computer configuring the control unit 100 may be a determination ECU that determines driving tasks in the driving control of the vehicle. The dedicated computer constituting the control unit 100 may be a monitoring ECU that monitors the driving control of the vehicle. The dedicated computer constituting the control unit 100 may be an evaluation ECU that evaluates the driving control of the vehicle.

In a modification, the dedicated computer of the control unit 100 may be a navigation ECU that navigates a travel route of the vehicle. The dedicated computer constituting the control unit 100 may be a locator ECU that estimates a self-state quantity of the vehicle. The dedicated computer that constitutes the control unit 100 may be an actuator ECU that individually controls the travel actuators of the vehicle. The dedicated computer constituting the control unit 100 may be a human machine interface (HMI) control unit (HCU) that controls information presentation in the vehicle. The dedicated computer that configures the control unit 100 may be a computer other than the vehicle, which configures an external center or a mobile terminal that can communicate with the vehicle, for example.

In a modification, the dedicated computer constituting the control unit 100 may include at least one of a digital circuit and an analog circuit as a processor. Here, the digital circuit refers to at least one type among, for example, an ASIC (Application Specific Integrated Circuit), FPGA (Field Programmable Gate Array), SoC (System on a Chip), PGA (Programmable Gate Array), and CPLD (Complex Programmable Logic Device). Such digital circuits may also include a memory for storing programs.

In a modification, the moving object to which the control unit 100 is applied may be, for example, an autonomous robot capable of transporting luggage or collecting information by autonomous driving or remote driving. Furthermore, as the autonomous device (autonomous robot), it may be an autonomous mobile robot including an autonomous vehicle.

The embodiments and modifications described above may be implemented as a control unit that is configured to be mountable on a mobile body and has at least one processor 102 and at least one memory 101. Specifically, the above-described embodiment and modified examples may be implemented in the form of a processing circuit (e.g., a processing ECU) or a semiconductor device (e.g., a semiconductor chip).

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A radar device comprising:
a transmission antenna;
a reception antenna; and
at least one of (i) a circuit and (ii) a processor having a memory storing computer program code executable by the processor, wherein
the at least one of the circuit and the processor is configured to generate types of transmitted signals, modulated by respective codes, for transmission from the transmission antenna,
the reception antenna is configured to receive a mixed received signal in which the transmitted signals, after being reflected by a reflector, are mixed,
the at least one of the circuit and the processor is configured to:
acquire the mixed received signal received by a specific reception antenna; and
generate decoded signals, corresponding to the respective codes for each transmitted signal;
the at least one of the circuit and the processor is configured to perform a removal process to:
estimate a sidelobe signal component, which is a received signal component detected in another decoded signal, in correlation with a target signal component, the target signal component being a received signal component corresponding to a transmitted signal targeted in a specific decoded signal;
remove the sidelobe signal component from the specific decoded signal or from a related signal associated with the decoded signals; and
set a correlation target of the sidelobe signal component as the target signal component of the specific decoded signal after a previous removal process, and
the at least one of the circuit and the processor is configured to:
determine a number of executions of the removal process to be at least correlated with a ratio of peak intensity to thermal noise intensity in the specific decoded signal prior to execution of the removal process; and
repeatedly perform the removal process for the determined number of times.

2. The radar device according to claim 1, wherein
the at least one of the circuit and the processor is configured to, prior to execution of the removal process, determine the number of executions of the removal process to be at least correlated with the ratio of the peak intensity to the thermal noise intensity and the number of peaks in the specific decoded signal, and execute the removal process for the determined number of times.

3. The radar device according to claim 1, wherein
the at least one of the circuit and the processor is configured to, prior to execution of the removal process, determine the number of executions of the removal process to be at least correlated with the ratio of the peak intensity to the thermal noise intensity and a Doppler frequency difference between peaks in the specific decoded signal, and execute the removal process for the determined number of times.

4. The radar device according to claim 1, wherein
the at least one of the circuit and the processor is configured to interrupt the removal process when the at least one of the circuit and the processor determines that an intensity of the sidelobe signal component in the specific decoded signal falls within an upper limit of an allowable intensity range.

5. The radar device according to claim 4, wherein
the at least one of the circuit and the processor is configured to terminate the removal process when the at least one of the circuit and the processor determines that the intensity of the sidelobe signal component, after executing the removal process for a prescribed number of times, falls within the upper limit of the allowable intensity range.

6. The radar device according to claim 1, wherein
the at least one of the circuit and the processor is configured to terminate the removal process when the at least one of the circuit and the processor determines that a peak having an intensity lower than the sidelobe signal component is not detected in the specific decoded signal obtained in a previous cycle.

7. The radar device according to claim 1, wherein
the at least one of the circuit and the processor is configured to terminate the removal process when the at least one of the circuit and the processor determines that a peak having an intensity lower than the sidelobe signal component is not detected in the specific decoded signal decoded from the mixed received signal received by another reception antenna.

8. A radar control method for controlling a radar device comprising a transmission antenna, a reception antenna, and at least one of (i) a circuit and (ii) a processor having a memory storing computer program code executable by the processor, the method comprising:
generating types of transmitted signals, modulated by respective codes, for transmission from the transmission antenna;
receiving, by the reception antenna, a mixed received signal in which the transmitted signals, after being reflected by a reflector, are included;
acquiring the mixed received signal received by a specific reception antenna;
processing the mixed received signal;
generating decoded signals, corresponding to the respective codes for each transmitted signal, by decoding the mixed received signal; and
performing a removal process, wherein
the removal process includes:
estimating a sidelobe signal component, which is a received signal component detected in another decoded signal, in correlation with a target signal component, the target signal component being a received signal component corresponding to a transmitted signal targeted in a specific decoded signal;
removing the sidelobe signal component from the specific decoded signal or from a related signal associated with the decoded signals; and
setting a correlation target of the sidelobe signal component as the target signal component of the specific decoded signal after a previous removal process,
the method further comprising:
determining a number of executions of the removal process to be at least correlated with a ratio of peak intensity to thermal noise intensity in the specific decoded signal prior to execution of the removal process; and
repeatedly performing the removal process for the determined number of times.

9. A non-transitory computer-readable storage medium storing a computer program comprising instructions that, when executed by a processor, cause the processor to control a radar device comprising a transmission antenna and a reception antenna, the instructions causing the processor to:
generate types of transmitted signals, modulated by respective codes, for transmission from the transmission antenna;
receive, by the reception antenna, a mixed received signal in which the transmitted signals reflected by a reflector are included;
acquire the mixed received signal received by a specific reception antenna;
process the mixed received signal; and
generate decoded signals, corresponding to the respective codes for each transmitted signal, by decoding the mixed received signal, wherein
the instructions causing the processor to perform a removal process to:
estimate a sidelobe signal component, which is a received signal component detected in another decoded signal, in correlation with a target signal component, the target signal component being a received signal component corresponding to a transmitted signal targeted in a specific decoded signal;
remove the sidelobe signal component from the specific decoded signal or from a related signal associated with the decoded signals;
set a correlation target of the sidelobe signal component as the target signal component of the specific decoded signal after a previous removal process, and
the instructions causing the processor to:
determine a number of executions of the removal process to be at least correlated with a ratio of peak intensity to thermal noise intensity in the specific decoded signal prior to execution of the removal process; and
repeatedly perform the removal process for the determined number of times.
